(19) United States
(12) Patent Application Publication
(10) Pub. No.: US 2005/0265290 A1
(43) Pub. Date: Dec. 1, 2005

(54) Feedback method for channel state information of a wireless link

(76) Inventors: Bertrand M. Hochwald, Summit, NJ (US); Thomas Louis Marzetta, Summit, NJ (US)

Correspondence Address: Lucent Technologies Inc.;Docket Administrator, Room 3J-219, 101 Crawfords Corner Road, Holmdel, NJ, 07733-3030, US

(21) Appl. No.: 10/856,236

(22) Filed: May 28, 2004

(51) Int. Cl. H04B 7/216

(52) U.S. Cl. 370/335

(57) ABSTRACT

The user terminals of a wireless communication system transmit forward channel state information (CSI) to a base station having two or more antennas. The user terminals concurrently transmit pilot signals to the base station in the form of predetermined time sequences of values. The pilot transmissions of respective user terminals are orthogonal to each other, so that reverse CSI can be derived from the pilot signals as received at the base station. The user terminals also concurrently transmit sequences, referred to as “CSI sequences,” that encode channel coefficients for propagation from each of the base station antennas to the user terminals. The CSI sequences are transmitted within enough time of the pilot sequences for the base station to use reverse CSI derived from the pilot sequences to interpret the CSI sequences as received at the base station.

### FIELD OF THE INVENTION

This invention relates to the communication of operational information between the base station and the mobile stations, or other remote terminals, of a wireless network. More particularly, the invention relates to the communication of channel state information between the mobile stations and the base station.

### ART BACKGROUND

Research in the field of wireless communication has shown that using multiple antennas for forward-link transmission from the base station can advantageously increase the forward-link data-transmission rate and provide other benefits to the network. This effect is known in the context of, among others, Point-to-Point MIMO (Multiple Input-Multiple Output), Multiple Access Channel, and Broadcast Channel systems. In particular, it has been shown that in a scattering propagation environment, the total of rates to all users can grow linearly with the number of base-station antennas if the forward channel coefficients are known to the transmitter. This is true even if the user terminals only have one antenna apiece. (Below, we will refer to the collective knowledge of the forward channel coefficients as “forward Channel State Information (CSI).”

In operation, a base station can readily estimate the reverse channel coefficients by, e.g., making measurements on pilot signals transmitted by the mobile stations. If the propagation channel obeys the law of reciprocity, these estimates can be taken as also representing the forward channel. However, as is well known, the assumption of reciprocity is often invalid, particularly when the two carrier frequencies differ significantly as in, e.g., a Frequency Division Duplex (FDD) system. If reciprocity cannot be assumed, the base station must rely on, e.g., measurements that the mobile stations take on forward-link pilot signals and then transmit to the base station.

It is also necessary for the base station to receive the measurement with only short delay. For example, for a carrier frequency of 1.9 GHz, a mobile station traveling at 30 meters per second will move one quarter wavelength in 1.3 milliseconds. This will generally be enough to cause a significant change in the channel coefficient.

Unfortunately, the transfer of the forward channel coefficients over the reverse channel is subject to noise, interference, and channel fluctuations. This transfer of information is often viewed as a primary bottleneck in teaching the base station the forward channel in, e.g., an FDD system. This is especially so when block coding techniques are used to improve data rates at the cost of further processing delay.

### SUMMARY OF THE INVENTION

We have discovered that as the number of MIMO antennas at the base station increases, the network gains that result can more than compensate for the burden of learning additional forward channel coefficients at the base station. As a consequence, the extra time burden for transmitting forward channel CSI over the reverse channel will often be less than is typically expected.

In a broad aspect, then, our invention involves a method of transmitting forward channel CSI from a user terminal such as a mobile station of a wireless communication system to a base station having two or more antennas. The user terminal transmits a pilot signal to the base station in the form of a predetermined time sequence of values. Concurrent pilot transmissions by a plurality of user terminals are envisaged, and thus the pilot transmission of a particular user terminal will typically be concurrent with the pilot transmission from at least one other user terminal. The pilot transmissions of respective user terminals are orthogonal to each other, so that reverse CSI can be derived from the pilot signals as received at the base station. The user terminal also transmits a sequence, referred to here as a “CSI sequence,” in which is encoded a channel coefficient for propagation from each of the base station antennas to the user terminal. Concurrent CSI transmissions by a plurality of user terminals are envisaged, and thus the CSI transmission of a particular user terminal will typically be concurrent with the CSI transmission from at least one other user terminal. The CSI sequence is transmitted within enough time of the pilot sequence for the base station to use reverse CSI derived from the pilot sequence to interpret the (forward) CSI sequence as received at the base station.

It is important to note that the scheme described above does not require the various users to share any forward or reverse CSI information.

In a second aspect of the invention, the base station receives the pilot signal from the user terminal via the two or more base-station antennas and derives reverse CSI from the pilot signal as received. The base station uses a known orthogonality property of the pilot signals to distinguish the pilot signal from pilot signals concurrently transmitted by one or more further user terminals. The base station also receives the CSI sequence from the user terminal. Using the reverse CSI derived from the pilot signal, the base station derives from the CSI sequence, as received, the transmitted value of the forward channel coefficient from each base-station antenna to the user terminal.

### BRIEF DESCRIPTION OF THE DRAWINGS

FIG. 1 is a functional block diagram illustrating the forward and reverse propagation channels of a wireless communication system in which the base station is equipped with an array of multiple antennas.

FIG. 2 is a diagram illustrating the transmission of a pilot signal from the base station to a plurality of user terminals for the purpose of measuring the forward CSI at the user terminals in the communication system of FIG. 1.

FIG. 3 is a diagram illustrating the transmission of a pilot signal from the user terminals to the base station for the purpose of measuring the reverse CSI at the base station in the communication system of FIG. 1.

FIG. 4 is a diagram illustrating the transmission of forward CSI from the user terminals to the base station, according to the invention in an illustrative embodiment.

### DETAILED DESCRIPTION

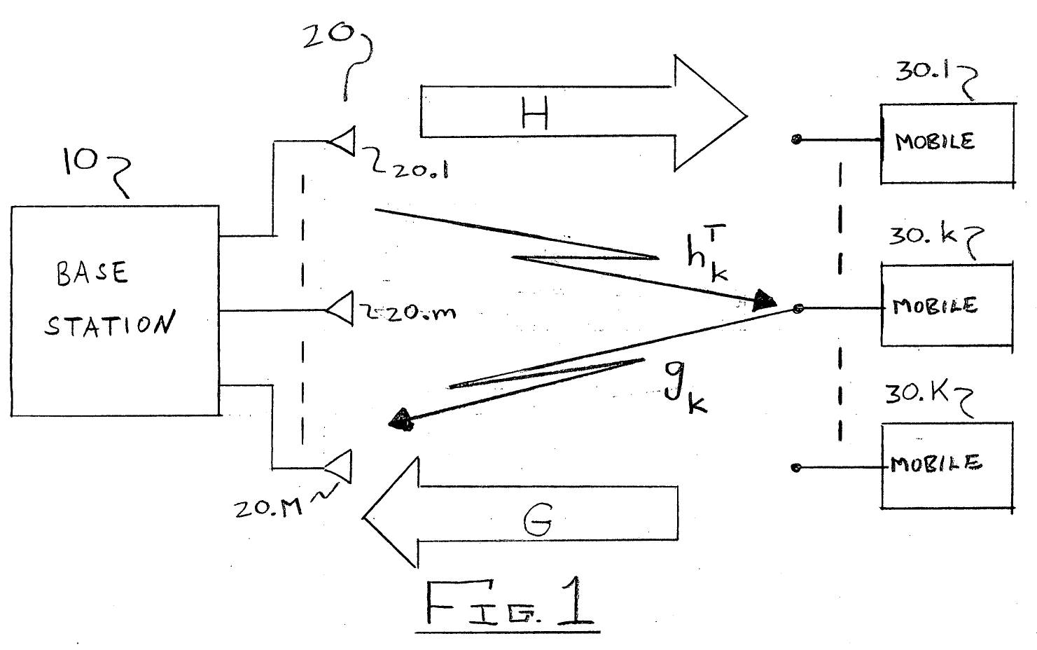

FIG. 1 shows an illustrative wireless communication system in which base station 10 communicates via array 20 of M antennas numbered for reference as 20.1, . . . , 20.m, . . . , 20.M. The number M of array antennas is at least 2. The base station communicates with K users, exemplarily the mobile stations numbered for reference as 30.1, . . . , 30.k, . . . , 30.K. Typically, K will be greater than M; that is, the number of users will exceed the number of array antennas.

At any given moment, the Channel State Information (CSI) which characterizes the propagation channel is expressed by a forward (downlink) propagation matrix H and a reverse (uplink) propagation matrix G. The forward propagation matrix H may be regarded as a column of the form

$$H = [ \begin{matrix}{h}_{1}^{T} \\ ⋮ \\ {h}_{K}^{T}\end{matrix} ] ,$$

in which the k'th entry is the 1×M propagation vector from array 20 to the k'th user terminal; that is, hₖ^{T}=[hₖ₁, . . . , h_{kM}] and hₖₘ is the propagation coefficient from the m'th antenna of the array to the k'th user terminal. It should be noted that in our notation, all untransposed vectors are column vectors and transposition is designated by the superscript symbol “T”. Similarly, the reverse propagation matrix G may be regarded as a row of the form G=[g₁, . . . , g_{K}], in which the k'th entry is the M×1 propagation vector from the k'th user terminal to the base-station array; that is,

$${g}_{k} = [ \begin{matrix}{g}_{k1} \\ ⋮ \\ {g}_{kM}\end{matrix} ]$$

and gₖₘ is the propagation coefficient from the k'th user terminal to the m'th antenna of array 20.

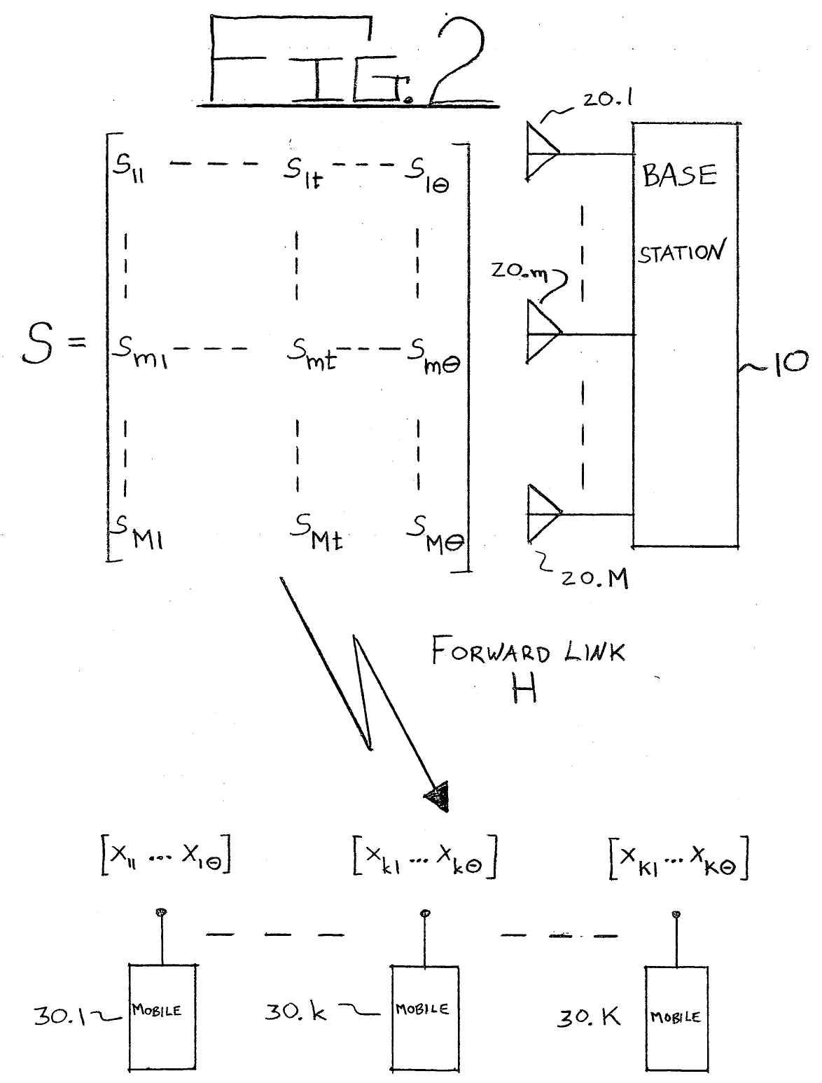

To enable the users to learn the CSI on the forward link, i.e., on the forward propagation channel, base station 10 transmits M×Θ matrix S, which consists of a time sequence of Θ vectors [s₁ . . . s_{Θ}], wherein Θ is at least M. Each vector consists of one value transmitted from each of the M array antennas. The transmissions from the respective array antennas are coordinated such that one vector sₜ is transmitted in each of the time intervals t, t=1, . . . , Θ. (The time interval in which one such vector is transmitted is referred to here as a “symbol interval.”) The transmitted vector S is indicated in FIG. 2.

The transmitted vectors are predetermined and known to the users. They are mutually orthogonal and scaled to satisfy a power constraint. In the normalization that we have here adopted for convenience, the matrix S is proportional to a unitary matrix, i.e., it satisfies SS*=C·I, wherein [●]* designates conjugate transposition, C is some constant, and I is the M×M identity matrix.

As shown in FIG. 2, the k'th user receives over the forward channel, due to the transmission of matrix S, a time sequence [xₖ₁ . . . x_{kΘ}]. Because, by prearrangement, user k knows matrix S, each user k, k=1, . . . , K, can readily form an estimate ĥₖ^{T} of forward propagation vector hₖ^{T} by taking the product

$${\hat{h}}_{k}^{T} = \frac{1}{C} \cdot [ {x}_{k1} … {x}_{k Θ} ] {S}^{*} .$$

Each vector ĥₖ^{T} is an estimate of a row of the forward propagation matrix.

The length Θ of the training sequences can be chosen to be large enough that the users may learn the forward CSI with a desired level of accuracy. The total training time will be proportional to M but independent of K.

In order to properly interpret messages from the users, including the users' transmission of forward-link CSI, the base station must learn the CSI for the reverse link. In the example described here, we assume that the base station first acquires the reverse-link CSI by receiving a pilot signal from the users, and then receives the users' transmission of forward-link CSI. However, this order of events is not essential. The pilot signal from the users may alternatively be received after the transmission of forward-link CSI.

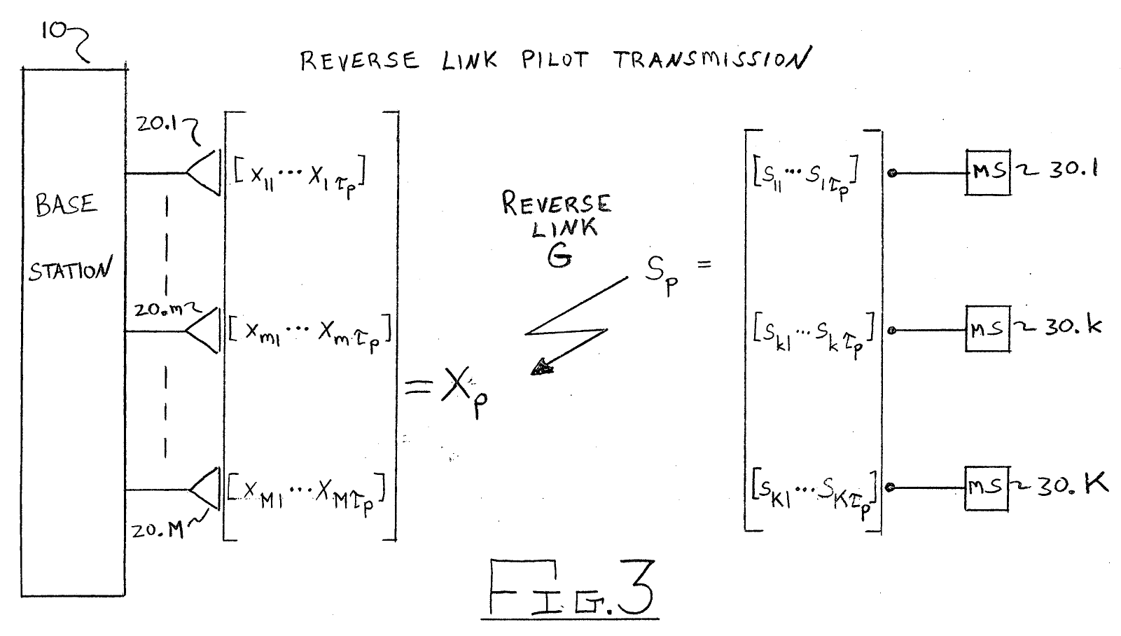

To enable the base station to learn the reverse-link CSI, the users collectively transmit a pilot signal in the form of matrix Sₚ, which has K rows and τₚ columns. The matrix Sₚ is prearranged and known to the base station. It is the product of a unitary matrix Φ times a normalization constant chosen to enforce a power constraint. As shown in FIG. 3, each row of Sₚ is a time sequence of values transmitted from an individual user terminal. Thus, for example, user k transmits the sequence [sₖ₁ . . . s_{kτ}_{ₚ}] over the course of τₚ successive symbol intervals.

The pilot signal as received at the base station array is the M×τₚ matrix Xₚ=GSₚ+Wₚ, wherein the matrix Wₚ accounts for receiver noise and interference. As indicated in FIG. 3, each row of the matrix Xₚ is a time sequence of τₚ values received at a respective one of the array antennas. For example, the m'th antenna receives a time sequence [xₘ₁ . . . x_{mτ}_{ₚ}].

Because the base station knows the matrix Sₚ, it can readily compute an estimate Ĝ of the reverse propagation matrix G. Two exemplary such estimates are provided here, under a normalization in which φφ*=I where I is the K×K identity matrix, and Sₚ=\sqrt{τₚPφ} where under a maximum power constraint an individual user's maximum transmit power is P:

The MMSE (minimum mean-square error) estimate is

$$\hat{G} = ( \frac{\sqrt{{τ}_{p} P}}{β + {τ}_{p} P} ) {X}_{p} {Φ}^{*} ,$$

where β represents the ratio of the variance of the combined interference and noise at the base station to the variance of each component of the reverse propagation matrix G.

The ML (maximum likelihood) estimate is

$$\hat{G} = \frac{1}{\sqrt{{τ}_{p} P}} {X}_{p} {Φ}^{*} .$$

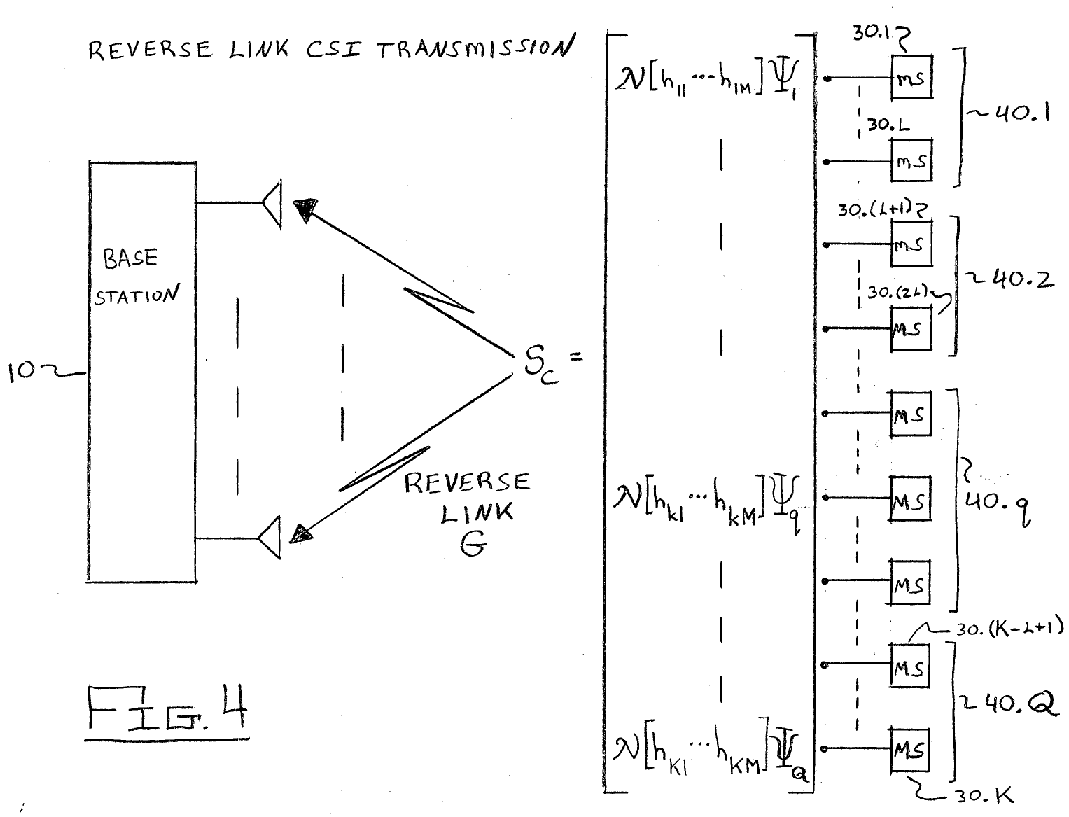

If the above procedures have been followed, each user will have an estimate of a respective row of the forward propagation matrix, and the base station will have an estimate of the reverse propagation matrix. Now, as illustrated in FIG. 4, the users can collectively transmit a matrix S_{c} in which the forward channel CSI has been encoded in a manner to be described below, and S_{c} can be properly interpreted by the base station when it is received there.

As noted above, each user has acquired an estimate of a respective row of the forward propagation matrix H. Each of these CSI estimates can be subjected to processing before it is transmitted on the matrix S_{c}. For example, it may in some cases be advantageous to quantize the CSI estimate and digitally code it, e.g. by channel coding it and modulating it onto a PSK or QAM constellation. Such processing is useful, inter alia, for reducing the dynamic range of the signal or for error correction.

On the other hand, the delay caused by quantization and coding may cause the CSI to be out of date by the time it is transmitted. Therefore, in at least some cases it will be advantageous to place the CSI onto the matrix S_{c} in a form which is “analog” in the sense that each user directly modulates its carrier with its CSI estimate.

Of course there are various other ways to advantageously process the CSI estimates, none of which are excluded. For example, analog or digital processing may be used to provide a logarithmic or other range-compressing function of the raw CSI estimates or at least of their magnitudes, with phase information appended to each compressed magnitude estimate. For illustrative purposes, and without limitation, we will assume below that the users send their CSI in analog form.

The matrix S_{c} has K rows, one for each of the users. The transmission of S_{c} on the reverse link occupies τ_{c} symbol intervals, one for each column of the matrix. In general, under a peak power constraint, the total time required to transfer the CSI to the base station will tend to be less if all of the user terminals transmit continuously during the τ_{c} symbol intervals.

In the system that we have described, one way for the base station to individually distinguish multiple users that are transmitting simultaneously on the same frequency is by using spreading matrices. That is, each user's CSI, as a column vector

$${h}_{k} = [ \begin{matrix}{h}_{k1} \\ ⋮ \\ {h}_{kM}\end{matrix} ] ,$$

is mapped onto a new column vector of length τ_{c} by premultiplying hₖ by a respective τ_{c}×M unitary matrix. If all of the spreading matrices are mutually orthogonal, the base station receiver can readily select the transmission from a given user by multiplying the received signal by the conjugate transpose of the corresponding spreading matrix.

It should be noted in this regard that if all the spreading matrices are unitary and mutually orthogonal, it follows that if any two vectors are spread by premultiplying them by distinct spreading matrices, the resulting spread vectors will be orthogonal to each other.

One disadvantage of the exclusive use of spreading matrices is the length of the matrices that are required if all K users are to be distinguished. That is, for all of the spreading matrices to be mutually orthogonal, the number τ_{c} of rows of each spreading matrix, which is also the number of symbol intervals required for transmission of the mapped CSI, must be at least KM. However, this number may be prohibitively large. For example, if the base station array has four antennas, and there are 40 users transmitting concurrently, the number of symbol intervals required for transmission of the CSI will be at least 160. Such a large transmission time may not be feasible, because it may exceed the fading interval of the communication system.

Another way for the base station to individually distinguish multiple users is by using the inherent beam-forming properties of the M-antenna array at the base station. That is, if no more than M individual users are transmitting concurrently, the base station receiver can discriminate one user's transmission from another by multiplying the received signal by an inverse or pseudoinverse of the reverse propagation matrix. As noted, however, this approach has the severe disadvantage that it can distinguish no more than M individual users.

We have overcome the limitations of both of the methods described above by adopting a composite approach which combines elements of both of the above-described methods. We divide the K user terminals into Q groups of L terminals each. (Q is the least integer greater than or equal to K/L.) There must be no more than M terminals in each of these groupings; that is, L≦M. The L terminals in each grouping share the same unitary spreading matrix Ψ_{q}, q=1, . . . , Q, having M rows and τ_{c} columns. To preserve the orthogonality of the spreading matrices, τ_{c} must be greater than or equal to QM. Selected groupings of L user terminals are indicated in FIG. 4 by the reference numerals 40.1, 40.2, . . . , 40.q, . . . , 40.Q. In FIG. 4, the user terminals in the first grouping are indicated by reference numerals 30.1-30.L, those in the second grouping by 30.(L+1)−30.(2L), and those in the last grouping by 30.(K−L+1)−30.K.

In general, the L user terminals in the q'th grouping are numbered k=(q−1)L+1, . . . , qL. According to an exemplary procedure, the CSI for the k'th user in this group, now in the form of a row vector hₖ^{T}, is postmultiplied by the corresponding spreading matrix. That is, the k'th user in the q'th grouping transmits a time sequence described by a column vector of length τ_{c} given by Nhₖ^{T}Ψ_{q}, wherein the normalization constant under the power constraint we have adopted here is given by

$$𝒩 = \sqrt{\frac{{τ}_{c} P}{M}} .$$

The matrix S_{c} sent over the reverse channel to the base station array is the collective sum of all the column vectors transmitted by the respective user terminals. The resulting signal received at the base station array is given by X_{c}=GS_{c}+W_{c}. When the matrix product in the preceding expression is written explicitly, we have:

$${X}_{c} = \sqrt{\frac{{τ}_{c} P}{M}} {\sum }_{q = 1}^{Q} {\sum }_{k = ( q - 1 ) L + 1}^{qL} {g}_{k} {h}_{k}^{T} {Ψ}_{q} + {W}_{c} ,$$

where W_{c} accounts for combined interference and receiver noise.

At the basestation, X_{c} is despread with each of the known matrices Ψ_{q} to obtain, for each q,

$${X}_{c} {Ψ}_{q}^{*} = \sqrt{\frac{{τ}_{c} P}{M}} {G}^{( q )} {H}^{( q )} + {W}_{c}^{( q )} .$$

In the preceding expression, W_{c}^{(q)} accounts for noise and interference. G^{(q)} is an M×L matrix whose columns give the reverse channel coefficients gₖ for the user terminals in the q'th grouping, and H^{(q)} is an L×M matrix whose rows give the forward channel coefficients hₖ^{T} for the user terminals in the q'th grouping. That is,

$${G}^{( q )} = [ {g}_{( q - 1 ) L + 1} , … , {g}_{qL} ] , and {H}^{( q )} = [ \begin{matrix}{h}_{( q - 1 ) L + 1}^{T} \\ ⋮ \\ {h}_{qL}^{T}\end{matrix} ] .$$

One way to obtain the estimate Ĥ^{(q)} of the forward CSI for the q'th grouping of user terminals is for the base station to perform a maximum-likelihood (ML) estimate assuming that the previously obtained estimate Ĝ of the reverse channel is accurate. (Thus, this may be thought of as a “pseudo” ML estimate.) The estimate is computed as follows, in which Ĝ^{(q)} is the previously obtained reverse channel estimate, limited to those L columns that represent channel coefficients for the user terminals in the q'th grouping:

$${\hat{H}}^{( q )} = \sqrt{\frac{M}{{τ}_{c} P}} {( {\hat{G}}^{( q ) *} {\hat{G}}^{( q )} )}^{- 1} {\hat{G}}^{( q ) *} {X}_{c} {Ψ}_{q}^{*} .$$

For each grouping q, what is obtained is an L×M matrix, each of whose rows gives the estimate of the forward channel coefficients for a respective user terminal in the q'th grouping.

Although it has been assumed in the preceding discussion that each user terminal has only one antenna, the principles described above also apply to communication systems in which each user terminal has multiple antennas. In such a case, the procedures described above can be applied without substantial modification if each individual user antenna is treated for these purposes as a separate user.

Alternatively, assuming that each user terminal has N>1 antennas, each user transmits its forward CSI to the base station as an N×M forward propagation matrix. This can be done, e.g., by having each user terminal post-multiply its forward propagation matrix by an M×τ_{c} unitary spreading matrix, resulting in a coded matrix of dimension N×τ_{c}. The coded matrix, in turn, is transmitted from the user terminal's N-antenna array as a time sequence of τ_{c} vectors, each of dimension N.

It should be noted in this regard that if user terminals have multiple antennas, each reference in the above discussion to distinguishing between respective users should be understood to mean distinguishing between respective user terminal antennas, since the different antennas belonging to a given user will in general be complementary rather than redundant, and will in general have different propagation coefficients.

The embodiments described above are merely illustrative, and are not meant to exclude other solutions to the technical problems described above from the scope of the invention. For example, instead of transmitting pilot signals before or after the transmittion of forward CSI, the users may make concurrent pilot and CSI transmissions by making appropriate use of orthogonality properties.

As a further example, “pilot” transmissions on the forward or reverse link may be made in accordance with the principles of blind identification, in which message-bearing signals enable the receiver simultaneously to recover the message and estimate the channel. In such instances, the message signal is implicitly also the pilot signal, and the need for an explicit pilot signal is obviated. Our use of the term “pilot” signal is meant to include such implicit pilot signals.

1. A method for communicating information concerning the state of the propagation channel of a wireless communication system, said information communicated from a user terminal of said system having at least one antenna to a base station of said system having at least two antennas, the method comprising:
(a) transmitting a pilot sequence from the user terminal to the base station;
(b) encoding a channel coefficient for propagation from each of the base station antennas to at least one antenna of the user terminal by forming a vector or matrix of a function of said channel coefficients and multiplying said vector or matrix by a further matrix, to be referred to as a spreading matrix, thereby to convert said vector to a sequence, denominated a CSI sequence, for transmission from the user terminal to the base station; and
(c) transmitting the CSI sequence from the user terminal to the base station, wherein:
(d) the pilot sequence is transmitted concurrently with a pilot sequence from at least one further user terminal of said system;
(e) the CSI sequence is transmitted concurrently with a CSI sequence from at least one further user terminal; and
(f) the CSI sequence is transmitted within a short enough time of the pilot sequence for the base station to use channel information derived from the pilot sequence to interpret the CSI sequence as received at the base station.

2. The method of claim 1, wherein the function of the channel coefficients is a linear, analog function.

3. The method of claim 1, wherein the spreading matrix is adapted such that an orthogonality property can be used to distinguish the CSI sequence that results from the encoding step from the CSI sequences that result from encoding steps carried out by at least some other user terminals within said system.

4. The method of claim 3, wherein the user terminal belongs to a grouping of user terminals that share a spreading matrix in common.

5. The method of claim 3, wherein the spreading matrix is adapted such that the CSI sequence that results from the encoding step is orthogonal to the CSI sequences that result from encoding steps carried out by at least some other user terminals within said system.

6. The method of claim 1, further comprising, at the user terminal, computing the channel coefficient for propagation from each of the base station antennas to at least one antenna of the user terminal from a pilot signal transmitted from the base station antennas.

7. The method of claim 6, wherein the step of computing channel coefficients at the user terminal is carried out using a known orthogonality property to distinguish portions of the base station pilot signal transmitted from different base-station antennas.

8. The method of claim 1, wherein the step of transmitting a pilot sequence from the user terminal to the base station comprises transmitting a pilot sequence that is orthogonal to the pilot sequences available for transmission by at least some other user terminals within said system.

9. A method for communicating information concerning the state of the propagation channel of a wireless communication system, said information communicated from user terminals of said system, each having at least one antenna, to a base station of said system having at least two antennas, the method comprising:
(a) receiving reverse-link pilot sequences concurrently transmitted from the antennas of a plurality of user terminals to the base station;
(b) receiving sequences, denominated CSI sequences, concurrently transmitted from the antennas of the plurality of user terminals to the base station;
(c) using the received reverse-link pilot sequences to interpret the received CSI sequences;
(d) applying one or more despreading matrices to the received CSI sequences, wherein each despreading matrix serves to isolate information communicated by one user or user group from information communicated by other users or user groups, thereby to obtain at least one vector or matrix of forward channel information for at least one user; and
(e) from at least one of said vectors or matrices of forward channel information, obtaining a value which is a function of a channel coefficient for propagation from each of the base station antennas to at least one antenna of at least one user terminal.

10. The method of claim 9, wherein the function of the channel coefficients is a linear, analog function.

11. The method of claim 9, wherein each despreading matrix uses a known orthogonality property to distinguish the CSI sequences transmitted by some user terminal antennas from the CSI sequences concurrently transmitted by some other user terminal antennas.

12. The method of claim 11, further comprising the step of using measured data to distinguish the CSI sequences transmitted by some user terminals from the CSI sequences concurrently transmitted by other user terminals, wherein said measured data comprises channel coefficients derived from the reverse link pilot sequences received by the base station.

13. The method of claim 12, wherein the known orthogonality property is used to separate the concurrently transmitting user terminal antennas into respective groupings, and the measured data is used to distinguish individual user terminals within each grouping.

14. The method of claim 9, further comprising, before receiving the CSI sequences, transmitting to the user terminals a composite forward-link pilot signal from a plurality of base-station antennas, wherein the contribution to the forward-link pilot signal from each base-station antenna is orthogonal to the contributions from the other base-station antennas.

15. The method of claim 9, further comprising using a known orthogonality property to distinguish each reverse-link pilot sequence transmitted by a user terminal antenna from each other concurrently transmitted reverse-link pilot sequence.
